(19) United States
(12) Patent Application Publication
(10) Pub. No.: US 2025/0131630 A1
(43) Pub. Date: Apr. 24, 2025

(54) PROP DISPLAY METHOD, APPARATUS, DEVICE, AND STORAGE MEDIUM

(71) Applicant: Beijing Zitiao Network Technology Co., Ltd., Haidian District, Beijing (CN)

(72) Inventors: Huaiye SHEN, Beijing (CN); Shentao WANG, Beijing (CN)

(21) Appl. No.: 18/833,713

(22) PCT Filed: Jan. 17, 2023
(86) PCT No.: PCT/CN2023/072496

§ 371 Date: Jul. 26, 2024

(30) Foreign Application Priority Data
Jan. 28, 2022 (CN) 202210107141.8

(51) Int. Cl. G06T 13/20; G06T 19/00

(52) U.S. Cl. CPC G06T 13/205; G06T 19/006

(57) ABSTRACT

An effect prop display method, an apparatus, a device, and a storage medium. The method comprises: receiving a trigger operation on an effect prop in an execution device, wherein the execution device currently has first position and orientation information (S101); displaying, in a set display state, an enhancement effect of the effect prop (S102); receiving a position and orientation adjustment operation on the execution device, wherein the first position and orientation information of the execution device is changed into second position and orientation information (S103); and keeping displaying the enhancement effect of the effect prop based on maintaining the set display state (S104).

### CROSS-REFERENCE TO RELATED APPLICATIONS

The present disclosure claims the priority to Chinese Application No. 202210107141.8, filed in the China Patent Office on Jan. 28, 2022, and the disclosure of which is incorporated herein by reference in its entity.

### FIELD

Embodiments of the present disclosure relate to the technical field of augmented reality (AR), for example, to a effect prop display method, and an apparatus, a device and a storage medium.

### BACKGROUND

An AR technology is also referred to as augmented reality, the AR technology may not only effectively reflect the content of a real world, but also may prompt the display of virtual information content, and these virtual contents complement and overlap with each other. With the development of network technologies, the AR technology is increasingly applied to live streaming and short video application software, and may enhance visual effects in live streaming interfaces or short video interfaces by means of providing AR effect props.

However, the display states of enhancement effects presented by the AR effect props in related arts tend to be adjusted with the adjustment of the poses of electronic devices, and it cannot be ensured that the enhancement effects are always displayed in appropriate display states, thereby affecting the usage experience of users.

### SUMMARY

Embodiments of the present disclosure provide a effect prop display method to effectively optimize the display state of an enhancement effect of a effect prop.

In a first aspect, an embodiment of the present disclosure provides a effect prop display method, including:
receiving a trigger operation of a effect prop in an execution device, wherein the execution device currently has first pose information;
displaying an enhancement effect of the effect prop in a set display state;
receiving a pose adjustment operation on the execution device, wherein the first pose information of the execution device is changed into second pose information; and
keeping displaying the enhancement effect of the effect prop while maintaining the set display state.

In a second aspect, an embodiment of the present disclosure further provides a effect prop interaction apparatus, including:
a first receiving module, configured to receive a trigger operation of a effect prop in an execution device, wherein the execution device currently has first pose information;
a first displaying module, configured to display an enhancement effect of the effect prop in a set display state;
a second receiving module, configured to receive a pose adjustment operation on the execution device, wherein the first pose information of the execution device is changed into second pose information; and
a second displaying module, configured to maintain the set display state, and continue to display the enhancement effect of the effect prop.

In a third aspect, an embodiment of the present disclosure further provides an electronic device, including:
a processor; and
a storage apparatus, configured to store a program, wherein,
when the program is executed by the processor, the processor implements the effect prop display method provided in any embodiment of the present disclosure.

In a fourth aspect, an embodiment of the present disclosure further provides a computer-readable storage medium, on which a computer program is stored, wherein the computer program implements, when being executed by a processor, the effect prop display method provided in any embodiment of the present disclosure.

### BRIEF DESCRIPTION OF THE DRAWINGS

To illustrate technical solutions in exemplary embodiments of the present disclosure, a brief introduction on the drawings which are needed in the description of the embodiments is given below. Apparently, the introduced drawings are merely drawings of some embodiments of the present disclosure but not all the drawings, and based on these drawings, other drawings may be obtained by those ordinary skilled in the art without any creative effort.

FIG. 1 is a schematic flowchart of a effect prop display method provided in Embodiment 1 of the present disclosure;

FIG. 1a to FIG. 1c illustrate effect display diagrams when a firework prop performs enhancement effect rendering by means of related arts;

FIG. 1d to FIG. 1f illustrate effect display diagrams when a firework prop performs enhancement effect rendering by means of the method provided in the present embodiment;

FIG. 2 is a schematic structural diagram of a effect prop interaction apparatus provided in Embodiment 2 of the present disclosure; and

FIG. 3 is a schematic structural diagram of an electronic device provided in Embodiment 3 of the present disclosure.

### DETAILED DESCRIPTION OF EMBODIMENTS

Hereinafter, embodiments of the present disclosure will be described with reference to the drawings. Although some embodiments of the present disclosure have been illustrated in the drawings, it should be understood that the present disclosure may be implemented in various forms, and should not be construed as being limited to the embodiments set forth herein. It should be understood that the drawings and embodiments of the present disclosure are for exemplary purposes only.

It should be understood that, various steps recorded in method embodiments of the present disclosure may be executed in different sequences and/or in parallel. In addition, the method embodiments may include additional steps and/or omit executing the steps shown.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present disclosure are only intended to distinguish different apparatuses, modules or units, rather than limiting the sequence of functions executed by these apparatuses, modules or units or a mutual dependency relationship. It should be noted that, the modifiers of “one” and “more” mentioned in the present disclosure are illustrative, and those skilled in the art should understand that the modifiers should be interpreted as “one or more” unless the context clearly indicates otherwise.

### Embodiment 1

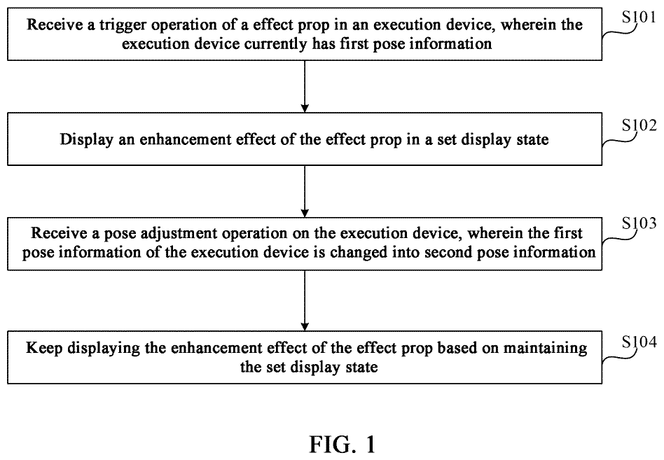

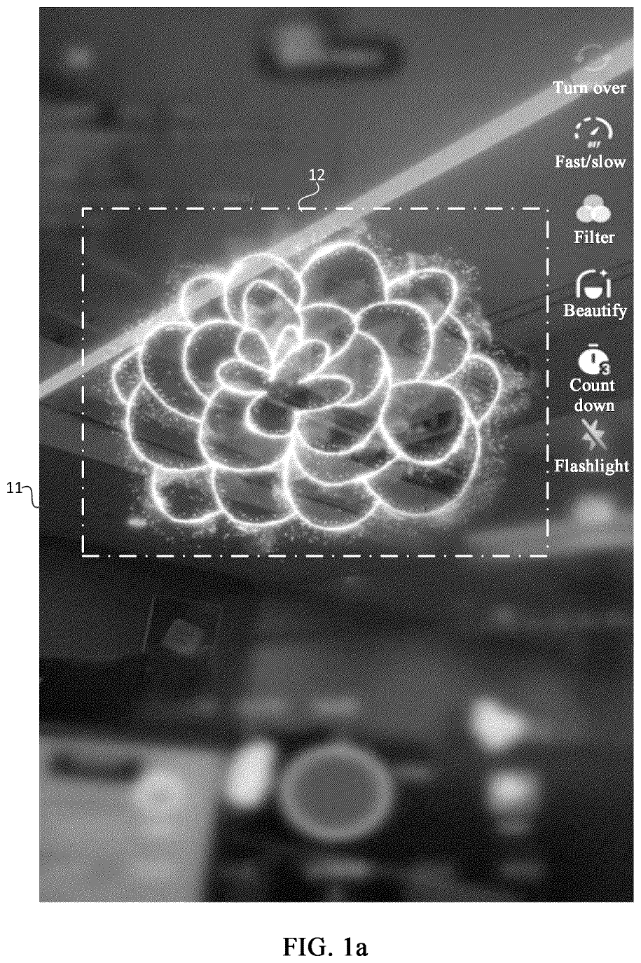

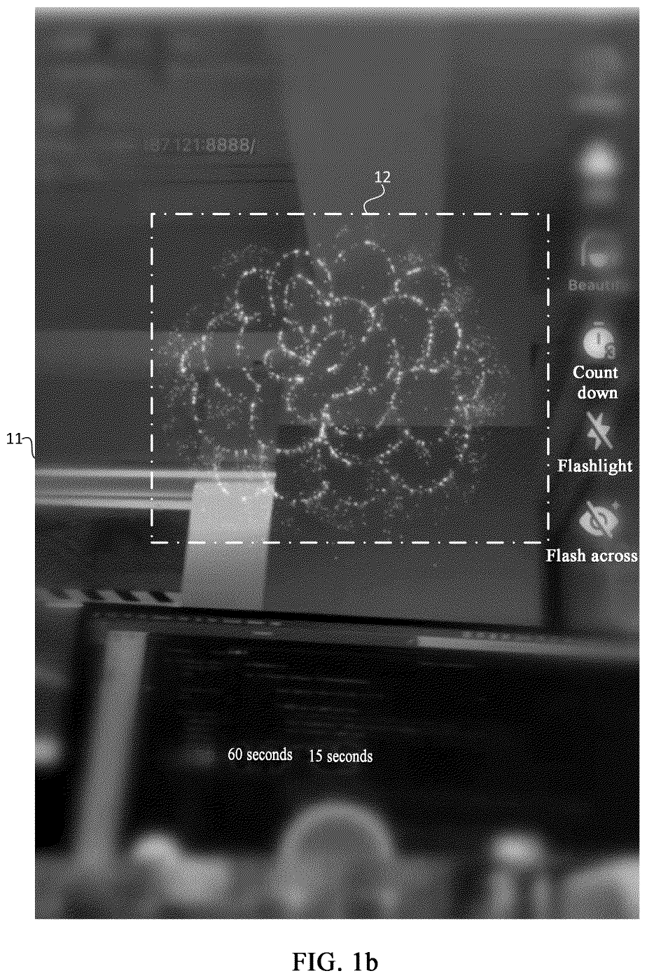

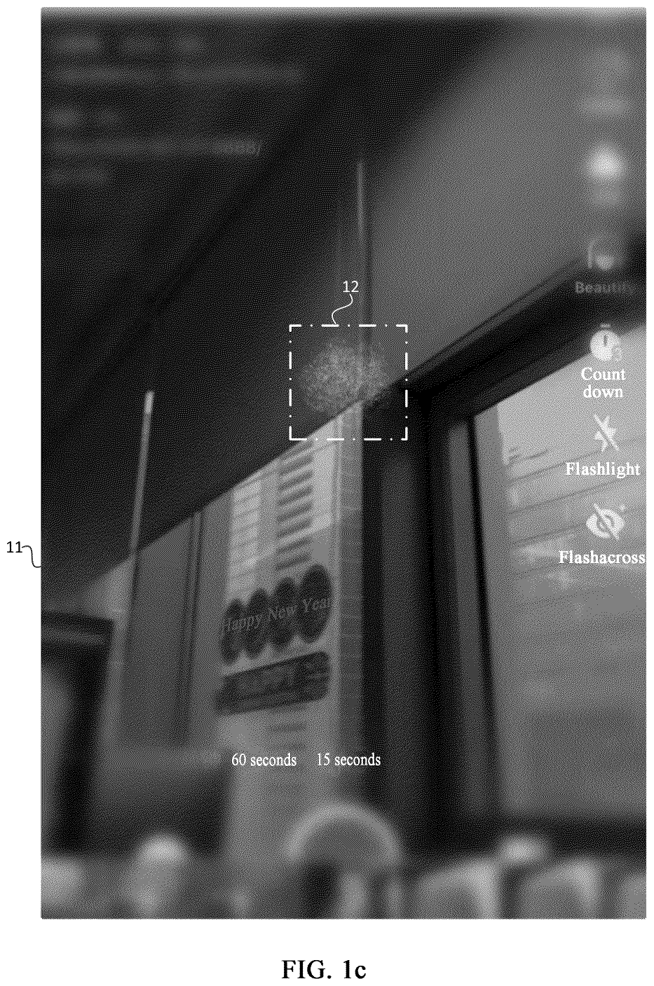

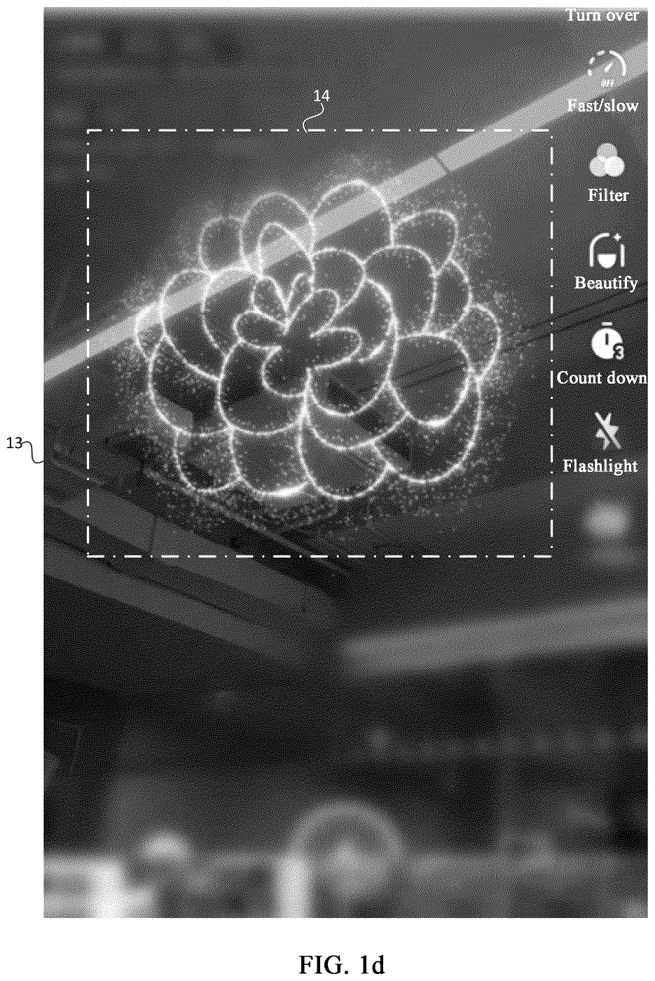

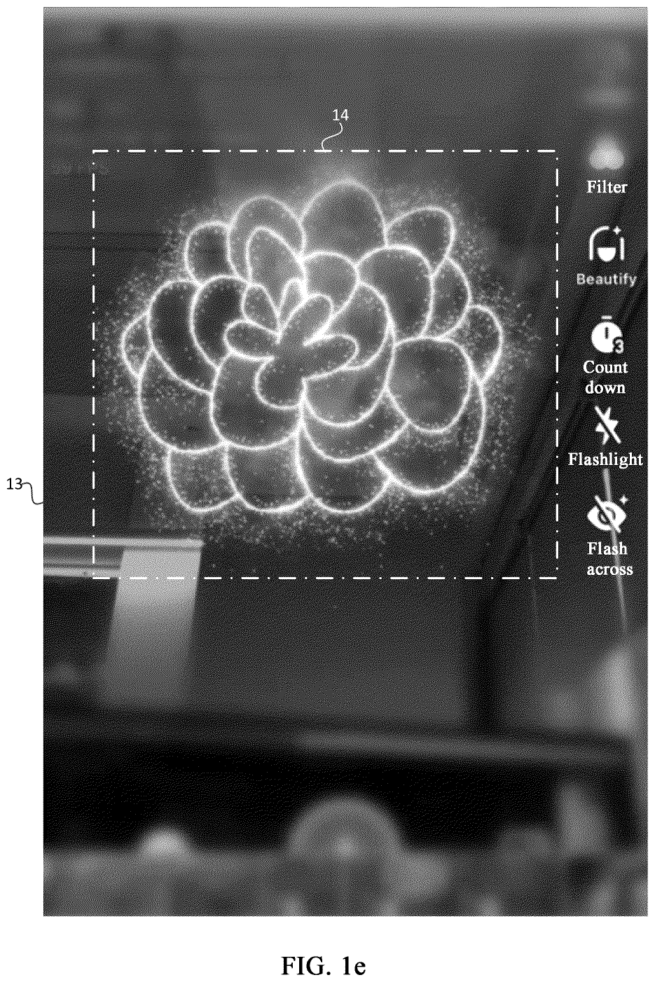

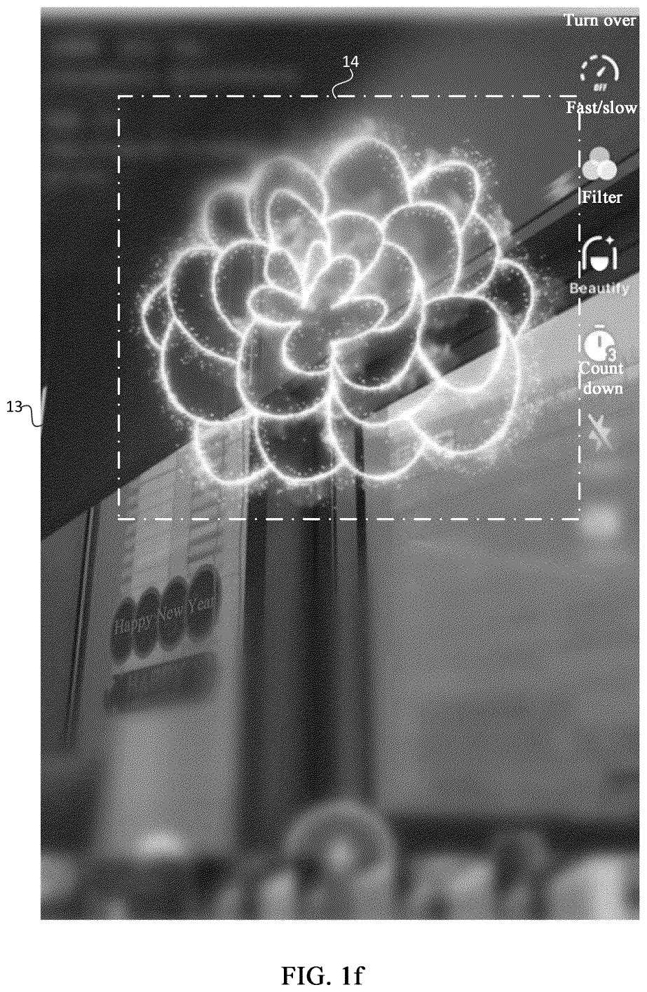

FIG. 1 is a schematic flowchart of a effect prop display method provided in Embodiment 1 of the present disclosure, the present embodiment may be applicable to a case where an enhancement effect of a effect prop is optimized, the method may be executed by a effect prop interaction apparatus, and the apparatus may be implemented by software and/or hardware, and may be configured in an electronic device, such as a terminal and/or a server, to implement the effect prop display method in the embodiment of the present disclosure.

It should be noted that, in the application of entertainment software such as live streaming and short videos in related arts, effect props of an augmented reality type have been provided, effect rendering may be performed on actual application scenarios such as live streaming or short videos by means of effect props, and visual rendering in the effect rendering is the most common. Generally, the effect rendering of the effect props is mainly implemented in an augmented reality scenario.

In an actual application scenario, when visual rendering is performed by means of a effect prop, a visual rendering process is mainly implemented in the augmented reality scenario, and finally is projected onto the screen of a device by means of a related visual rendering data picture, so that an enhancement effect of visual rendering can be displayed in the actual application scenario. The augmented reality scenario may be considered to be a three-dimensional space, in which a camera (a virtual camera) is provided, a effect virtual object corresponding to the effect prop during visual rendering may be captured by means of the camera, and then a visual enhancement effect of the effect prop may be displayed in the actual application scenario by means of projecting the captured effect virtual object on the screen of the device.

When effect rendering is performed in the augmented reality scenario in the related arts, the display state of a rendering picture (which may be the display size of the rendering picture), which is presented by the effect prop on the screen of an electronic device, changes (e.g., the presentation size becomes smaller or greater along with a change in the pose electronic device) along with the change (e.g., rotation or inclination) in the pose of the electronic device. The above rendering manner has the problem that, after the effect prop is started, the display state of a effect picture presented by the effect prop on the screen of the electronic device may be relatively suitable for the actual application scenario. Along with the change in the pose of the electronic device, when the display state of the effect picture is also changed, the display state presented by the effect picture may be not matched with the actual application scenario, or may be not required by a user.

Or, there may also be the following problems: after the user adjusts the pose of the electronic device to adjust the effect picture presented by the effect prop to a display state required by the user, since the electronic device cannot keep one pose unchanged all the time during a handheld process of the user, the display state may also be adjusted due to the adjustment of the pose of the electronic device, leading to a change in the display size presented by the effect picture, thereby affecting the enhancement rendering effect of the effect prop.

Taking a firework prop in the effect prop as an example, FIG. 1a to FIG. 1c illustrate effect display diagrams when the firework prop performs enhancement effect rendering by means of the related arts. FIG. 1a to FIG. 1c respectively include a first reality scenario picture 11 captured by the camera of the electronic device, and a first firework effect picture 12 rendered by the firework prop in an augmented reality scenario, wherein the augmented reality scenario is a three-dimensional space, a virtual camera is disposed in the space and may be used for inputting effect content of the effect prop, and the firework effect picture is equivalent to the effect content of the firework prop.

It can be assumed that, the first reality scenario picture 11 in FIG. 1a is a picture captured when the electronic device is in a first pose, the first reality scenario picture 11 in FIG. 1b is a picture captured when the electronic device is in a second pose, the first reality scenario picture 11 in FIG. 1c is a picture captured when the electronic device is in a third pose, the first pose, the second pose and the third pose have different pose information, and the first pose may be used as an initial pose after the firework effect is started.

The first firework effect pictures 12 in FIG. 1a to FIG. 1c may be considered to be different picture frames when animation rendering is performed in an enhancement effect displayed by the firework prop, and present different effect contents, for example, the first firework effect picture 12 in FIG. 1a mainly displays effect content at the moment of firework explosion, the first firework effect picture 12 in FIG. 1b mainly displays one frame of effect content after the firework explosion, and the first firework effect picture 12 in FIG. 1C mainly displays effect content at the moment of secondary blooming after the firework explosion. Although the effect contents presented in the first firework effect pictures 12 in FIG. 1a to FIG. 1c are changed, however if the pose of the electronic device remains unchanged, the first firework effect pictures 12 in FIG. 1a to FIG. 1c will be displayed in the same display size.

However, as can be seen from FIG. 1a to FIG. 1c, along with the change in the pose of the electronic device, the display size, on the screen of the electronic device, of the first firework effect picture 12 rendered in the augmented reality scenario is actually changed. Moreover, it can be seen that the display size of the rendered first firework effect picture 12 is gradually reduced in FIG. 1a to FIG. 1c, and obviously the display size of the first firework effect picture 12 with the reduced size in FIG. 1c is too small to meet the rendering requirements of the user in the actual application scenario.

On this basis, the present embodiment provides a effect prop display method. By means of the method provided in the present embodiment, the display state of the effect picture rendered by the effect prop may be decoupled from the pose of the mounted electronic device, so that when the pose of the electronic device is changed, it can still be ensured that the effect picture is presented on the screen of the electronic device in an appropriate display state.

As shown in FIG. 1, the effect prop display method provided in Embodiment 1 may include:

S101, receiving a trigger operation of a effect prop in an execution device, wherein the execution device currently has first pose information.

In the present embodiment, the execution device may be understood as an electronic device that executes the method provided in the present embodiment, for example, may be a mobile terminal such as a mobile phone or a tablet computer. Application software with an augmented reality function is installed on the electronic device, the application software may be software of a live streaming type or a short video type, and the augmented reality function may be integrated into the application software as a plug-in. Exemplarily, the augmented reality function may be presented in an application window interface as a effect prop function option, and a prop frame including at least one effect prop may be presented by means of triggering the effect prop function option by the user.

In the present embodiment, as one example, the trigger operation of the effect prop in the present step may be a trigger of the user for any effect prop in the displayed prop frame, and the trigger operation of the user for one effect prop may be received in the present step. The effect prop may be any effect prop launched by an application software developer, such as a firework effect, a petal rain effect, and the like.

It should be noted that in the present step, the pose information of the pose of the execution device may be acquired when the user triggers the effect prop, and the pose information is used as the first pose information in the present embodiment, wherein the pose information may include space coordinates of the execution device in a set space coordinate system, and the space coordinates may represent position information of the execution device, and may also represent information presented by the execution device, for example, an attitude angle, and the like. Exemplarily, in the present embodiment, related pose information may be captured by a gyroscope in the execution device.

S102, displaying an enhancement effect of the effect prop in a set display state.

In the present embodiment, the present step may be used as a response step of S102, that is, with respect to receiving the trigger operation of the effect prop, the present step may respond to the trigger operation, so that the enhancement effect of the selected effect prop may be displayed on the current screen interface of the execution device, and may be displayed in the set display state.

In the present embodiment, the enhancement effect may be understood as effect content rendered by the effect prop, different effect props may correspond to different effect contents, and the enhancement effect may include a visual enhancement effect, an auditory enhancement effect and a tactile enhancement effect. For example, the effect content rendered by the firework prop may be firework explosion and firework blooming, and the vibration of the execution device may also be experienced during the firework explosion, which may be considered to be enhancement effects of the firework prop in the application scenario.

In the present embodiment, the set display state may be understood as a display form of the rendered enhancement effect when same is displayed by the execution device after the effect prop is rendered, wherein the display form may include an audio form related to the auditory sense, a picture form related to the visual sense, and a vibration sense form related to the tactile sense.

The audio form related to the auditory sense may be reflected in the playing form of a rendered sound enhancement effect, for example, may be played by a speaker or an earphone of the device; the vibration sense form related to the tactile sense may be reflected in a vibration form of a rendered vibration enhancement effect, for example, vibration may be performed via a vibration assembly on the device; and the picture form related to the visual sense may be reflected in the display position and the display size of a rendered effect enhancement picture on the screen of the device.

It should be noted that, the S101 and the S102 in the present embodiment may be considered to be conventional execution steps after the effect prop is started. As can be seen from the above exemplary description, during the process of displaying the enhancement effect, the pose of the execution device may be changed according to actual application requirements, and when the pose of the execution device is changed, the display state of the enhancement effect (especially the visual enhancement effect) rendered by the effect prop is changed accordingly. In the present embodiment, the following S103 and S104 provide an effective improvement for the above problems, and effective decoupling between the pose of the execution device and the display state of the enhancement effect is realized by the following S103 and S104, such that the display state of the enhancement effect is not changed with the adjustment in the pose of the execution device.

S103, receiving a pose adjustment operation on the execution device, wherein the first pose information of the execution device is changed into second pose information.

In the present embodiment, pose change monitoring may also be performed on the execution device in the implementation of the method, that is, whether the execution device is rotated or moved may be monitored, if the above pose change exists, which is equivalent to that the pose adjustment operation is performed, and then the pose adjustment operation may be received by means of the present step. It can be understood that, in the present embodiment, the pose information of the execution device after pose adjustment may be obtained and may be denoted as the second pose information. Compared with the first pose information of the execution device, a space coordinate position or attitude angle of the execution device may be changed in the second pose information.

S104, keeping displaying the enhancement effect of the effect prop while maintaining the set display state.

In the present embodiment, the present step may be considered to be response execution of the pose adjustment operation received in the S103, in the response execution, the display state of the enhancement effect of the effect prop on the screen of the device is still maintained to be the set display state in the S102, and the display of the enhancement effect of the effect prop may be continued on the basis of the execution device before pose adjustment, without affecting the display progress of the enhancement effect.

Exemplarily, if the enhancement effect of the effect prop is a segment of animation rendering, it is assumed that animation rendering is performed to a second picture frame in the S102 prior to the pose adjustment of the execution device, and if the pose of the execution device is adjusted at this time, the display of a third picture frame may be continued in the S104, which responds to the adjustment operation, following the second picture frame displayed in the animation rendering. By means of the present step, on the screen of the execution device, the display size of the displayed third picture frame is the same as the display size corresponding to the third picture frame prior to the pose adjustment of the execution device, and at the same time, if the screen position where the animation rendering is presented on the screen of the device is not manually adjusted, subsequent picture frames of the animation rendering are still displayed at original screen positions on the screen of the device.

Taking the visual enhancement effect of the effect prop as an example, in a conventional implementation, the display size of a effect enhancement picture displayed by the visual enhancement effect on the screen of the device may be adjusted along with the adjustment in the pose of the execution device. The reason may be described as: assuming that the visual rendering data of the effect prop is presented as a effect virtual object in the augmented reality scenario, the effect enhancement picture presented on the screen of the device may be considered to be a projection on the screen of the device after the camera in the augmented reality scenario captures the effect virtual object. The augmented reality scenario is associated with a space coordinate system where the execution device is located, thereof if the pose of the execution device is adjusted, the capture angle of the camera in the augmented reality scenario is adjusted as well, so that the size of a capture picture of the effect virtual object captured by the camera is also adjusted, and when the size of the capture picture is adjusted, the display size of the effect enhancement picture projected on the screen of the device is also adjusted.

Based on the above description, in the present step, when the pose of the execution device is adjusted, considering that the camera in the control augmented reality scenario still has the original capture angle, when the original capture angle is kept unchanged, it can be ensured that the size of the capture picture of the captured effect virtual object is unchanged, so that the display size of the effect enhancement picture projected on the screen of the device can be kept unchanged, and finally, the display state of the enhancement effect of the effect prop may be kept unchanged at a visualization level.

Exemplarily, one implementation in the present step for controlling the camera in the augmented reality scenario to still have the original capturing angle may be: setting a limiting condition, that is, a capture angle of view plane of the effect virtual object always faces the camera in the augmented reality scenario, and after the limiting condition is known, an augmented reality plane meeting the limiting condition may be determined from the augmented reality scenario as the capture angle of view plane to capture the effect virtual object.

It can be seen that in the present step, after the camera in the augmented reality scenario is controlled to maintain the original capture angle of view in response to the above pose adjustment operation, the same set display state as the S102 may be maintained at the visualization level, and the display of the enhancement effect of the effect prop is continued.

It should be noted that, the method provided in the present embodiment provides a display implementation of the effect prop after once adjustment in the pose of the execution device. However, the present embodiment is not limited to displaying only once pose adjustment, as long as the pose of the execution device is adjusted, the steps S103 and S104 in the present embodiment may be cyclically executed to ensure that the display state of the enhancement effect of the effect prop can always remain unchanged in the pose adjustment of the execution device.

To facilitate better understanding of the method provided in the present embodiment, the present embodiment is described via one example. Still taking the firework prop in the effect prop as an example, FIG. 1d to FIG. 1f illustrate effect display diagrams when the firework prop performs enhancement effect rendering by means of the method provided in the present embodiment. Similarly, FIG. 1d to FIG. 1f also respectively include a second reality scenario picture 13 captured by the camera of the electronic device, and a second firework effect picture 14 rendered by the firework prop in the augmented reality scenario, wherein the augmented reality scenario has been described above.

Similarly, it can be assumed that the second reality scenario picture 13 in FIG. 1d is a picture captured when the electronic device is in a fourth pose, the second reality scenario picture 13 in FIG. 1e is a picture captured when the electronic device is in a fifth pose, and the second reality scenario picture 13 in FIG. 1f is a picture captured when the electronic device is in a sixth pose, wherein the fourth pose, the fifth pose and the sixth pose have different pose information, and the fourth pose may be used as an initial pose after the firework effect is started.

In addition, the second firework effect pictures 14 in FIG. 1d to FIG. 1f may also be considered to be different picture frames when animation rendering is performed on the enhancement effect displayed by the firework prop, and represent different effect contents, for example, the second firework effect pictures 14 in FIG. 1d to FIG. 1f respectively show one frame of effect content in a firework blooming process, wherein the effect contents of the second firework effect pictures 14 shown in FIG. 1d to FIG. 1f are changed.

It can be seen that, along with the change in the position of the execution device in FIG. 1d to FIG. 1f, the display size, on the screen of the device, of the second firework effect picture 14 rendered in the augmented reality scenario remains unchanged. If the fourth pose of the execution device in FIG. 1d is used as the initial pose, it can be seen that the effect contents presented by the second firework effect pictures 14 in the subsequent FIG. 1e and FIG. 1f are continuations of the effect content presented in FIG. 1d.

In the technical solution of the present embodiment, the display state of the enhancement effect of the effect prop is given after the effect prop is started and when the execution device is in the first pose, and when the pose of the execution device is adjusted to the second pose different from the first pose, the enhancement effect of the effect prop may be still controlled to maintain the previous display state, thereby avoiding the situation that the display state of the displayed enhancement effect is adjusted to another display state with a poor display effect along with the change in the pose of the execution device. By means of the above technical solution, it can be ensured that the enhancement effect of the effect prop is always maintained in an appropriate display state, thereby optimizing the enhancement effect of the effect prop, so that the electronic device can effectively present the enhancement effect in each pose, and the usage experience of the user is better improved.

As a first optional embodiment of the present Embodiment 1, on the basis of the present Embodiment 1, in the present first optional embodiment, the enhancement effect may include a visual enhancement effect; and correspondingly, the S102: displaying the enhancement effect of the effect prop in the set display state, may include: playing an animation enhancement effect of the effect prop in the augmented reality scenario, and presenting the animation enhancement effect at a set screen position of the execution device in a predetermined effect display size.

In the present optional embodiment, the enhancement effect of the effect prop is the visual enhancement effect, and the visual enhancement effect may be understood as that the effect content of the effect prop is displayed on the screen of the device in the form of a effect image or a effect animation. In the present embodiment, the effect content of the enhancement effect may be selected as the effect animation, that is, the animation enhancement effect may be played on the screen of the device.

It can be seen that, in the implementation of augmented reality, the effect content of the effect prop is actually equivalent to being presented in a specific three-dimensional augmented reality scenario, and is synchronously presented on the screen of the device via projection processing. Therefore, the enhancement effect displayed in the present embodiment is actually equivalent to firstly playing the animation enhancement effect in the augmented reality scenario by means of outputting rendering data of the virtual camera; and then, synchronously displaying the animation enhancement effect on the screen of the device by means of projecting the augmented reality scenario onto the screen of the device.

In the present optional embodiment, the set display state for presenting the animation enhancement effect may be presented at a set screen position of the execution device in the effect display size. Exemplarily, the effect display size may be determined by the current first pose information of the execution device, a selected or preset screen position on the screen of the device (i.e., the set screen position mentioned above), and an augmented reality plane used when the camera in the augmented reality scenario captures the effect virtual object. Finally, in the present first optional embodiment, the animation enhancement effect of the effect prop may be displayed at the set screen position in the determined effect display size.

As a second optional embodiment of the present Embodiment 1, on the basis of the above first optional embodiment, during the process of playing the animation enhancement effect, the present second optional embodiment further includes: when the animation enhancement effect is played to a preset time point, superimposing a light enhancement effect and presenting the same.

In the present optional embodiment, the visual enhancement effect of the effect prop is optimized, and other effects are superimposed on the animation enhancement effect. For example, in order to better present the effect of the effect prop, it is considered that the light enhancement effect is superimposed in the animation enhancement effect, and an increased time point of the light enhancement effect is also considered.

Exemplarily, in the effect presentation of the firework prop, the firework blooming process may be used as the presented animation enhancement effect, and on this basis, in order to better simulate the firework blooming effect in reality, a flash effect may also be added on the time point of firework explosion.

In the present optional embodiment, the added light enhancement effect may also be considered to be a segment of animation video or as an image frame with a flash pattern, therefore the image frame of the animation enhancement effect and the image with the flash pattern are synchronously played when playing to the preset time point, or the playing of the animation video of the light enhancement effect is started at the preset time point, thereby realizing the effect superposition of the animation enhancement effect and the light enhancement effect.

The superimposition of the light enhancement effect implemented in the present second optional embodiment improves the enhancement effect of the effect prop, thereby improving the usage experience of the effect prop by the user.

As a third optional embodiment of the present Embodiment 1, on the basis of any optional embodiment mentioned above, in the present third optional embodiment, “playing the animation enhancement effect of the effect prop in the augmented reality scenario” may include: acquiring a video file corresponding to the effect prop, wherein the video file is stored in a set video format; and decoding the video file, and playing decoded effect video frames in the augmented reality scenario.

It should be noted that, the present third optional embodiment is equivalent to an optimization of one step implementation in the first optional embodiment mentioned above, and provides an underlying operation implementation for playing the animation enhancement effect in the augmented reality scenario.

It should be understood that, the material of the presented animation enhancement effect may be considered to be a video file composed of combinations of a plurality of image frames, a common display form of the video file is a sequential combination of a series of image frames, and the file format of the video file may be denoted as a sequence frame. When the effect prop is used in the actual application scenario, it is often necessary to ensure the precision of the effect enhancement picture presented by the effect prop, that is, each image frame in the animation enhancement effect is required to have a high resolution. If a video file in a sequence frame format is used, when the number of high-resolution image frames contained in the animation enhancement effect is too large, the video file has a relatively large volume, which is not conducive to the storage of the video file. In the related arts, the volume of the video file may also be reduced in some manners, such as frame extraction and lossy image compression, but these manners may affect the resolutions of the image frames, which may affect the display effect of the animation enhancement effect in the actual application scenario.

In order to solve the problem of it being impossible to reduce the volume while ensuring the playing precision of the video file in the sequence frame format, the present third optional embodiment optimizes the file format of the video file used by the effect prop for enhancing the animation effect, the file format of the video file may be optimized to a set video format, such as an MP4 format. The conversion of the video file from the sequence frame format to the set video format may be implemented by a set format converter.

Taking conversion into the MP4 format as an example, an MP4 video file mainly uses the H.264 standard to perform video encoding on image frames, wherein H.264 may be considered to be a standard of a highly compressed data video encoder. By means of converting the video file into the video format, lossless compression of the video file may be implemented, thereby ensuring the playing precision of the video, and since the image is compressed, the volume of the video file is also greatly reduced. For example, after a sequence frame file with a size of 8.1 Mega (M) is converted into a file of the MP4 format by means of format conversion, the file size thereof may be reduced to 2.4 M.

Compared with a file of the sequence frame format for implementing the animation enhancement effect, the sequence frame format may directly and sequentially read image frames from the sequence frame file and play the image frames; however, the video file of the set video format (e.g., the MP4 format) for implementing the animation enhancement effect cannot be directly read and played in sequence. Therefore, the following content in the present third optional embodiment provides a step of processing the video file of the set video format to play the animation enhancement effect.

a1) Acquiring the video file corresponding to the effect prop, wherein the video file is stored in the set video format.

Exemplarily, the video file of the set video format may be pre-stored on the execution device, and a correspondence between the effect prop and the video file may be recorded to acquire the required video file by means of the present step.

b1) Decoding the video file, and playing decoded effect video frames in the augmented reality scenario.

It should be noted that, the decoding of the video file is a real-time execution process, that is, decoded image frames are played in the augmented reality scenario during decoding, and the image frame may be denoted as a effect video frame in the present embodiment. The video file is decoded to acquire the next played effect video frame during a real-time playing process, for example, to acquire the next effect video frame, it is necessary to know the position of the next effect video frame in the entire video file at first, the position may be obtained by means of determining the time point for playing the next frame in the video file, and the time point for playing the next frame may be determined according to the own playing parameters (the total playing duration, the playing rate and the like) of the video file and the current playing time point.

Therefore, in the present step, the next effect video frame to be played may be obtained by means of the own playing parameter of the video file and the current playing time point.

In the present third optional embodiment, the above step b1) may include:

b11) acquiring playing parameters and the current playing information of the video file.

The playing parameters may be considered to be attribute information preset for the video file, and the playing parameters may include a total playing duration, a playing rate, and the like. The current playing information may be understood as information related to the currently played effect video frame in the augmented reality scenario, for example, a playing time point corresponding to the effect video frame in the entire video file, and the playing time point may be denoted as the current playing time point.

b12) Decoding the next effect video frame to be played according to the playing parameters and the current playing information, and playing the next effect video frame to be played in the augmented reality scenario.

After the playing parameters are obtained, in combination with the current playing information, the playing time point corresponding to the next effect video frame in the entire video file may be determined at first, then image data information at the playing time point may be obtained from the video file, the next effect video frame capable of being presented in the form of an image may be obtained by means of combination processing on the image data information, and finally the next effect video frame may be output in the augmented reality scenario via the virtual camera. In this way, the playing of the next effect video frame is realized.

It can be seen that, the step b12) may be considered to be a circularly executed step, as long as a effect playing condition of the augmented reality scenario is met, the next effect video frame to be played may be obtained all the time through the step, wherein the effect playing condition may be a preset playing mode, and if the playing mode is playing once, after each effect video frame in the video file is placed once, the cycle of the step may be ended. If the playing mode is cyclic playing, each effect video frame in the video file needs to be circularly played for multiple times until a playing stop instruction is received.

In the present third optional embodiment, the step b12) may include:

b111) determining the next video frame index according to the playing parameters and the current playing information of the video file, and in combination with a set playing mode.

In the present optional embodiment, the set playing mode may be understood as a preset playing mode for playing effect video frames in the augmented reality scenario to present the animation enhancement effect. The playing mode may include: playing once, cyclic playing, cyclic playing from head to tail and then from tail to head. The playing parameters may include: a playing duration of the video file, a playing rate of the video file, and the number of included effect video frames. The next video frame index may be understood as a playing time point corresponding to the next effect video frame to be played in the video file.

The step b111) may include: extracting, from the playing parameter information, the playing duration of the video file, the playing rate of the video file and the number of effect video frames, and acquiring the current playing time point from the current playing information; determining a frame playing time of the video file according to the playing duration and the playing rate; determining the next video frame index on the basis of the number of frames, the current playing time point and the frame playing time, and in combination with a frame index computation formula corresponding to the playing mode.

In the present optional embodiment, the current playing time point may be considered to be a time point corresponding to the effect video frame, which is being played, in the video file. It can be seen that, if playing of the effect video frame is not started, the current playing time point may be 0 by default.

In the present optional embodiment, the time spent on playing one effect video frame of the video file may also be computed, and the time is denoted as the frame playing time.

Exemplarily, when the set playing mode is playing once, the determination steps of the next video frame index may include:
using, as a candidate time, the minimum time in the frame playing time and the current playing time point; and
multiplying the candidate time by the number of frames, dividing a product by the frame playing time, performing down rounding on a division result, and using, as the next video frame index, a time point obtained after down rounding.

Exemplarily, when the preset playing mode is cyclic playing, the determination steps of the next video frame index may include:
performing a remainder operation on the frame playing time and the current playing time point, and using a remainder result as a candidate time; and
similarly, multiplying the candidate time by the number of frames, dividing a product by the frame playing time, performing down rounding on a division result, and using, as the next video frame index, a time point obtained after down rounding.

Exemplarily, when the preset playing mode is cyclic playing from head to tail and then from tail to head, the determination steps of the next video frame index may include:
performing multiplication computation on the frame playing time, performing an area operation on a multiplication result and the current playing time point, and using a reminder result as a candidate time;
if the candidate time is greater than the frame playing time, performing a subtraction operation on the multiplied frame playing time and the original candidate time, and using a difference value of the operation as a new candidate time; and
similarly, multiplying the updated new candidate time by the number of frames, dividing a product by the frame playing time, performing down rounding on a division result, and using, as the next video frame index, a time point obtained after down rounding.

b112) Determining the next effect video frame to be played from the video file according to the next video frame index.

In the present optional embodiment, the next video frame index is obtained by means of the above steps, which is equivalent to obtaining a corresponding time point of the next video frame to be played in the video file, so that the next effect video frame to be played can be determined from the video file on the basis of the next video frame index. The data information of all the image channels related to the next effect video frame is obtained at first by means of the next video frame index, and then the data information of all the image channels is combined to obtain a texture image running in an image processing unit, and the texture image may be denoted as the next effect video frame.

The step b112) may include:

determining the next video frame playing position from the video file on the basis of the next video frame index; extracting data information of all the image channels contained in the next video frame playing position; and performing data mixing on the data information of all the image channels, and using an obtained texture image as the next effect video frame to be played in the video file.

In the present third optional embodiment, by means of converting the video file from the sequence frame format into the set video format, the video file is controlled to have a smaller volume while ensuring the playing precision of the animation enhancement effect. Meanwhile, an implementation for effectively playing the animation enhancement effect by using the video file of the set video format is provided. By means of the present third optional embodiment, the storage space of the execution device for storing the video file is effectively saved, and the resource occupation of the storage space of the video file is optimized.

As can be seen from the above description, in the present embodiment, by means of displaying the enhancement effect of the effect prop in the set display state, the animation enhancement effect of the effect prop may be played in the augmented reality scenario, and is presented at the set screen position of the execution device in the predetermined effect display size. The implementation of the present step mainly depends on an underlying logical operation.

In the present embodiment, in addition to supporting the playing of the animation enhancement effect by means of the underlying logical operation in the present third optional embodiment, the execution logical for determining the effect display size is provided in the following fourth optional embodiment.

As a fourth optional embodiment of the present Embodiment 1, on the basis of any optional embodiment mentioned above, during the process of playing the animation enhancement effect, the present fourth optional embodiment further includes: according to the first pose information of the execution device, determining the effect display size of each effect video frame in the animation enhancement effect on the screen of the device.

In the present optional embodiment, a determination step of the effect display size is added, the determination step is mainly executed in the playing process of the animation enhancement effect, and the determination step may also be considered to be a step synchronously executed with the playing of the animation enhancement effect, which may be used for determining the effect display size of effect video frames involved in the animation enhancement effect, wherein the effect display size may be a display size when the effect video frames are projected on the screen of the device.

Exemplarily, in the present step, the effect display size may be determined by means of the first pose information of the execution device, wherein the first pose information is the pose information of the execution device when executing the S102 in the present implementation. In the present optional embodiment, the effect prop has a effect virtual object in the augmented reality scenario, and the camera in the augmented reality scenario may capture the effect virtual object and present a corresponding animation enhancement effect on an augmented reality plane, and then the effect video frame presented on the augmented reality plane needs to be projected and displayed on the screen of the device.

Therefore, it can be seen that in the display of the animation enhancement effect on the screen of the device, it is necessary to rely on the camera (the virtual camera) in the augmented reality scenario, it is also necessary to rely on the augmented reality plane in the augmented reality scenario, and meanwhile, it is also necessary to know a desired presentation position when the animation enhancement effect is presented on the screen of the device.

The spatial position information, in an associated space coordinate system, of the camera (the virtual camera) in the augmented reality scenario may be determined by means of the pose information of the execution device. The augmented reality plane may be any plane in the augmented reality scenario. The desired presentation position on the screen of the device may be characterized by a set screen position on the screen of the device.

In the present fourth optional embodiment, according to the first pose information of the execution device, determining the effect display size of each effect video frame in the animation enhancement effect on the screen of the device, may include:

a2) according to the first pose information of the execution device, determining a space coordinate point of the camera in the augmented reality scenario.

Exemplarily, the current space coordinates of the execution device in the space coordinate system may be obtained by means of the first pose information, and the space coordinate point may be directly used as the space coordinate point of the camera in the augmented reality scenario in the present step.

b2) Acquiring initial plane information of a preset initial vertical plane in the augmented reality scenario.

It can be understood that, in order to ensure that the effect video frame of the animation enhancement effect may better adapt to the actual application scene, the effect video frame needs to be presented on the screen of the device in an appropriate effect display size.

In the present embodiment, after the effect prop is started, with respect to the execution device and the space coordinate system associated with the augmented reality scenario at this time, an appropriate augmented reality plane for determining the effect display size is preset, a limiting condition that the space coordinate system where the augmented reality plane is relatively located needs to met is perpendicular to a horizontal axis in the space coordinate system where the augmented reality plane is located, the distance from the plane to the origin of the space coordinate system is a set value, and the plane meeting the above limiting condition is denoted as the initial vertical plane in the present embodiment.

In the present step, the initial plane information of the determined initial vertical plane may be acquired.

c2) According to the space coordinate point and the initial plane information, and in combination with the set screen position, determining the effect display size of each effect video frame in the animation enhancement effect on the screen of the device.

In the present optional embodiment, it can be considered that the effect prop is present in the augmented reality environment as a effect virtual object. On the basis of the premise information, the implementation of the present step may be considered to follow a logical implementation, and the logical implementation may be described as: the camera in the augmented reality environment may capture the effect virtual object, and a related effect video frame of the captured effect virtual object is actually equivalent to being presented on the initial vertical plane; and pixel points of the related effect video frame presented on the initial vertical plane are projected on the screen of the device to display the animation enhancement effect on the screen of the device.

The known set screen position may be considered to be a picture center point of the displayed effect video frame. To ensure the effect display size of the effect video frame on the screen of the device, it is necessary to determine the display size of the effect video frame on the initial vertical plane at first, and the display size may be determined on the basis of the determined space coordinate point, the initial plane information and the set screen position.

In the present fourth optional embodiment, the step c2) may include:

c21) acquiring center point coordinates of the set screen position, and determining corresponding plane point coordinates of the center point coordinates on the initial vertical plane according to the space coordinate points and the initial plane information.

It can be understood that, the set screen position may be a position area (which may generally be a rectangular area), and the center point coordinates may be considered to be coordinates of the center point of the position area.

According to the mathematical logical principle, the space coordinate point of the camera, the initial plane information of one initial vertical plane and the center point coordinates on the screen of the device are known, after a ray passing through the center point coordinates is emitted from the position of the camera, the ray may intersect with the initial vertical plane, coordinate information of the intersection point may be determined in combination with the initial plane information, and the coordinate information of the intersection point is denoted as the plane point coordinates in the present step.

c22) For each effect video frame in the animation enhancement effect, determining, on the initial vertical plane by using the plane point coordinates as the picture center point coordinates of the effect video frame, pixel point coordinates of pixel points in the effect video frame, which are presented on the initial vertical plane.

It can be understood that, the effect virtual object of the effect prop is present in the augmented reality scenario in the form of the animation enhancement effect, the camera may capture each effect video frame in the animation enhancement effect, and each effect video frame is presented on the initial vertical plane.

After the position where the effect video frame should be presented on the screen of the device is defined, it is equivalent to determining the position where the effect video frame should be located on the initial vertical plane. In order to determine the position of each pixel point in the effect video frame on the initial vertical plane, corresponding plane point coordinates of the center point coordinates of the set screen position on the initial vertical plane may be used as the picture center point coordinates of the effect video frame.

Since the effect rendering data of the effect video frame may be obtained, after the picture center point coordinates are determined, the pixel point coordinates of the pixel points in the effect video frame, which are presented on the initial vertical plane, may be determined in combination with the effect rendering data.

c23) On the basis of the pixel point coordinates, determining a corresponding effect display size of the effect video frame on the screen of the device.

In the present optional embodiment, a corresponding projection matrix between the initial vertical plane and the screen of the device may be determined, after the pixel point coordinates are known, pixel projection coordinates projected by the effect video frame on the screen of the device may be determined, and finally the effect display size may be determined on the basis of the pixel projection coordinates.

The present fourth optional embodiment provides an underlying logical implementation for determining the effect display size, and provides an underlying logical operation support for displaying the enhancement effect of the effect prop in the present embodiment.

As a fifth optional embodiment of the present Embodiment 1, on the basis of any optional embodiment mentioned above, in the present fifth optional embodiment, the step S104: “keeping displaying the enhancement effect of the effect prop while maintaining the set display state”, may include:

a3) continuing to play the animation enhancement effect of the effect prop in the augmented reality scenario, and presenting the animation enhancement effect at the set screen position of the execution device in the effect display size.

In the present fifth optional embodiment, the above step is equivalent to giving an underlying logical description for supporting the implementation of S104. That is, if the enhancement effect of the effect prop is maintained to be displayed in the original set display state, the playing of the animation enhancement effect of the effect prop needs to be continued in the augmented reality scenario, and each effect video frame in the animation enhancement effect is maintained to be presented at the set screen position of the execution device in the determined effect display size.

As can be seen from the foregoing description of the present embodiment, after the pose of the execution device is changed, if it is necessary to maintain the enhancement effect to have the display state before pose adjustment at the visualization level, it is necessary to redetermine, at an underlying logical level and in the augmented reality scenario, an augmented reality plane for presenting each effect video frame in the animation enhancement effect.

In the present fifth optional embodiment, the presenting the underlying logical level at the set screen position of the execution device in the effect display size in step a3) may include:

a31) constructing a target vertical plane in the augmented reality scenario according to the second pose information of the execution device.

Exemplarily, the second pose information of the execution device is equivalent to the pose information of the execution device after once pose adjustment, and through the second position information, a new space coordinate system may be established for the execution device and the augmented reality scenario. Then, in the new space coordinate system, it is necessary to redetermine an augmented reality plane, which may be perpendicular to the horizontal axis of the space coordinate system and whose distance to the origin is a set value, and the augmented reality plane may be denoted as the target vertical plane in the present embodiment.

In the present embodiment, the construction of the target vertical plane may be converted into the corresponding space coordinate system when the execution device is in the first pose. In the space coordinate system, with respect to the second pose information of the execution device, it may be considered that the execution device is changed from the first pose to the second pose, the attitude angle thereof is rotated by a first rotation angle around the longitudinal axis in the space coordinate system, and a normal vector of the initial vertical plane may be obtained on the basis of the initial plane information of the initial vertical plane.

In the present embodiment, the normal vector may be adjusted on the basis of the first rotation angle, and the adjusted normal vector is used as a target normal vector of a target vertical plane to be constructed; and after it is determined that the distance between the target vertical plane to be constructed and the origin also needs to be kept at a set distance value, target plane information may be determined on the basis of the target normal vector and the set distance value, and finally the target vertical plane may be constructed on the basis of the target plane information.

It can be understood that, by means of the above description, the constructed target vertical plane is actually equivalent to be in front of the augmented reality scenario all the time. In this way, it can be ensured that the effect display size of the presented effect video frame always remains unchanged.

a32) Controlling the camera in the augmented reality scenario to capture the animation enhancement effect, and presenting the animation enhancement effect on the target vertical plane, so that the animation enhancement effect presented at the set screen position of the execution device maintains the effect display size.

In the present optional embodiment, the camera in the augmented reality scenario still continues to capture the animation enhancement effect of the effect prop, but at this time, the effect video frame of the animation enhancement effect is presented on the newly determined target vertical plane. The display size of the effect video frame of the animation enhancement effect presented on the target vertical plane is the same as the display size of the effect video frame presented on the target vertical plane. On the basis that the display size remains unchanged, the effect display size of the effect video frame of the animation enhancement effect, which is projected on the plane of the device for display, also remains unchanged.

Meanwhile, in the present embodiment, as long as the set screen position is not adjusted, a corresponding screen position on the execution device also remains unchanged.

The present fifth optional embodiment provides an underlying logical implementation for maintaining the effect display size unchanged, and provides an underlying logical operation support for maintaining the original display state of the enhancement effect of the effect prop in the present embodiment.

As a sixth optional embodiment of the present Embodiment 1, on the basis of any optional embodiment mentioned above, in the present sixth optional embodiment, the enhancement effect may include an auditory enhancement effect; and correspondingly, “displaying the enhancement effect of the effect prop in the set display state” may include:

in the augmented reality scenario, playing a sound enhancement effect of the effect prop at a set sound effect playing rate, wherein the sound enhancement effect is synchronously played with the animation enhancement effect of the visual enhancement effect that is included in the enhancement effect.

In the present optional embodiment, the enhancement effect of the effect prop is the auditory enhancement effect, and the auditory enhancement effect may be understood as that the effect content of the effect prop is output by an audio playing apparatus of the execution device in the form of audio. The auditory enhancement effect in the present embodiment may be used as an optimization of the enhancement effect of the effect prop, that is, the enhancement effect of the effect prop is no longer limited to visual enhancement, but the authenticity of the effect prop in the actual application scene is improved by adding the sound enhancement effect.

Taking the firework prop as an example, while playing effects, such as firework blooming and firework explosion, on the screen of the device, the firework prop may synchronously sound effects of the firework during playback and explosion by means of an audio output apparatus (e.g., a loudspeaker or an earphone) of the device to enhance the authenticity of the firework effect in the application scenario.

In the present optional embodiment, in order to ensure the synchronization of the sound enhancement effect and the animation enhancement effect in the visual enhancement effect, the playing rates of sound playing and the playing rate of the animation enhancement effects may be synchronously bound, wherein the synchronization of sound playing and video playing may be implemented by using a related algorithm in the technical field.

As a seventh optional embodiment of the present Embodiment 1, on the basis of any optional embodiment mentioned above, in the present seventh optional embodiment, the enhancement effect may include a tactile enhancement effect; and correspondingly, “displaying the enhancement effect of the effect prop in a set display state” includes:

a4) in the augmented reality scenario, when a vibration enhancement condition of the effect prop is met, presenting a vibration enhancement effect by means of controlling a vibration apparatus on the execution device.

In the present optional embodiment, the enhancement effect of the effect prop is the tactile enhancement effect, and the tactile enhancement effect may be understood as that the effect content of the effect prop is displayed by controlling the execution device to vibrate. The tactile enhancement effect often needs to be used in combination with the visual enhancement effect or the auditory enhancement effect. The vibration enhancement condition may be that a effect picture presented in the visual enhancement effect needs to be loaded with vibration, or a sound effect generated in the auditory enhancement effect needs to be loaded with vibration. In the present embodiment, a time point meeting the vibration enhancement condition may be determined, so that the vibration enhancement effect is presented at the determined time point by means of controlling the vibration apparatus on the execution device.

In the present seventh optional embodiment, the “presenting the vibration enhancement effect by means of controlling the vibration apparatus on the execution device” in the step a4) may include:

acquiring vibration parameter information corresponding to the currently satisfied vibration enhancement condition; and on the basis of the vibration parameter information, controlling the vibration apparatus to vibrate to present the vibration enhancement effect, wherein the vibration parameter information includes a vibration amplitude, a vibration frequency, and a vibration duration.

It can be understood that, when the effect prop plays the animation enhancement effect in the visual enhancement effect or the sound enhancement effect in the auditory enhancement effect, there may be a plurality of time points meeting the vibration enhancement condition in the playing process, therefore different vibration parameter information may be set for different time points in advance in the present embodiment, so that the vibration apparatus of the execution device can be controlled to vibrate at a corresponding time point according to the corresponding vibration parameter information.

Still taking the firework prop as an example, the execution device may be controlled to perform vibration effect enhancement at a firework explosion time point. The firework explosion time point may be the 0.05th second of playing the animation enhancement effect, and the corresponding vibration parameter information may be that the vibration amplitude is 0.16 mm, the vibration frequency is 0.92 Hz, and the continuous vibration time is 0.12 seconds. The vibration parameter information in the present embodiment is not limited to the above data, and may be any setting that meets the tactile enhancement effect of the effect prop, but the vibration amplitude and the vibration frequency may be valued between 0 and 1.

In the present optional embodiment, by means of adding the vibration enhancement effect, the authenticity of the effect prop in the actual application scenario may also be improved.

As an eighth optional embodiment of the present Embodiment 1, on the basis of any optional embodiment mentioned above, in the present eighth optional embodiment, the effect prop is a firework prop; and correspondingly, the enhancement effect corresponding to the firework prop includes a firework blooming animation, firework explosion sound, firework explosion flash, and a firework explosion vibration sense.

Exemplarily, when the effect prop is a firework prop, it is equivalent to that the user triggers a prop option of the firework prop. Then, by means of the method provided in the present embodiment, the animation enhancement effect of firework blooming is played at the set screen position on the screen of the execution device, and the sound effect of firework blooming is synchronously played in the firework blooming process, and due to the rendering of firework explosion in the firework blooming process, the explosion point may be enhanced with a flash effect, and meanwhile the explosion sound and the firework explosion vibration sense are emitted at the explosion point. Through the above series of operations, the enhancement effect of the firework prop is displayed more truly and effectively, and the user experience can be better improved.

Meanwhile, the display size of the animation effect of firework blooming in the visual enhancement effect of the firework effect is not changed along with the change in the pose of the execution device, so that the animation effect of firework blooming can be presented in a display size that is more suitable the application scenario to ensure the authenticity of the firework effect, and to improve the usage experience of the firework effect by the user as well.

### Embodiment 2

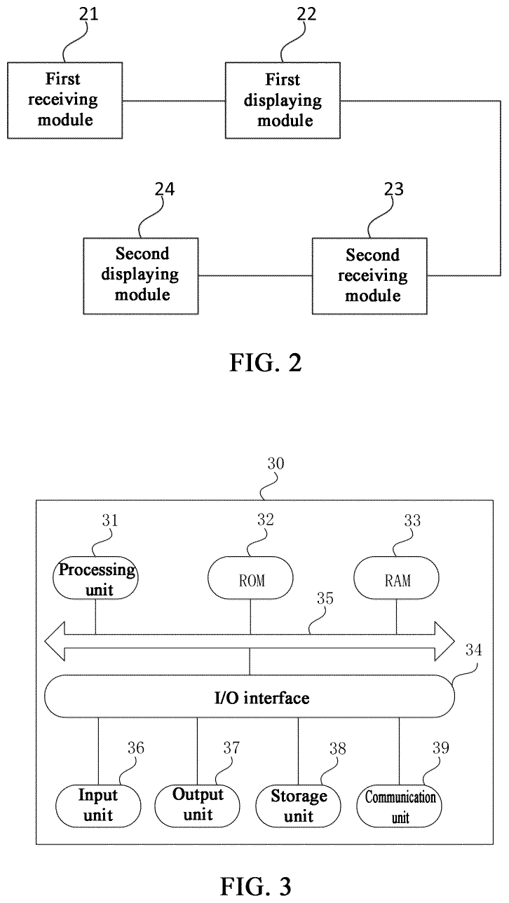

FIG. 2 is a schematic structural diagram of a effect prop interaction apparatus provided in Embodiment 2 of the present disclosure, the effect prop interaction apparatus provided in the present embodiment may be implemented by software and/or hardware, and may be configured in a terminal and/or a server to implement the effect prop display method in the embodiments of the present disclosure. The apparatus may include a first receiving module 21, a first displaying module 22, a second receiving module 23, and a second displaying module 24.

The first receiving module 21 is configured to receive a trigger operation of a effect prop in an execution device, wherein the execution device currently has first pose information;
the first displaying module 22 is configured to display an enhancement effect of the effect prop in a set display state;
the second receiving module 23 is configured to receive a pose adjustment operation on the execution device, wherein the first pose information of the execution device is changed into second pose information; and
the second displaying module 24 is configured to maintain the set display state, and continue to display the enhancement effect of the effect prop.

The effect prop interaction apparatus disclosed in the present Embodiment 2 provides a display state of the enhancement effect after the effect prop is started and when the execution device is in the first pose, and when the pose of the execution device is changed into a second pose different from the first pose, the enhancement effect of the effect prop may still be controlled to maintain the previous display state, thereby avoiding the display state of the enhancement effect of being adjusted to other display states with worse display effects along with the change in the pose of the execution device. By means of the above technical solution, it can be ensured that the enhancement effect of the effect prop is always maintained at an appropriate display state, thereby optimizing the enhancement effect of the effect prop, enabling the electronic device to present the enhancement effect in each pose, and better improving the usage experience of the user.

On the basis of any optional technical solution in the embodiment of the present disclosure, optionally, the enhancement effect includes a visual enhancement effect; and
correspondingly, the first displaying module 22 may include:
a visual enhancement unit, configured to play an animation enhancement effect of the effect prop in an augmented reality scenario, and present the animation enhancement effect at a set screen position of the execution device in a predetermined effect display size.

On the basis of any optional technical solution in the embodiment of the present disclosure, optionally, the first displaying module 22 may further include: a light effect enhancement unit; and

the light effect enhancement unit is configured to: during the process of playing the animation enhancement effect, when the animation enhancement effect is played to a preset time point, superimpose a light enhancement effect and present the same.

On the basis of any optional technical solution in the embodiment of the present disclosure, optionally, when playing the animation enhancement effect of the effect prop in the augmented reality scenario is executed in the visual enhancement unit, the visual enhancement unit may include:
an acquisition sub-unit, configured to acquire a video file corresponding to the effect prop, wherein the video file is stored in a set video format; and
a playing sub-unit, configured to decode the video file, and play decoded effect video frames in the augmented reality scenario.

The playing sub-unit is configured to play the decoded effect video frames in the augmented reality scenario in the following manner:
determining the next video frame index according to playing parameters and the current playing information of the video file, and in combination with a set playing mode; and
determining the next effect video frame to be played from the video file according to the next video frame index.
determining, by the playing sub-unit, the next video frame index according to the playing parameters and the current playing information of the video file, and in combination with the set playing mode, may include:
extracting, from the playing parameter information, a playing duration of the video file, a playing rate of the video file and the number of effect video frames, and acquiring the current playing time point from the current playing information;
determining a frame playing time of the video file according to the playing duration and the playing rate; and
determining the next video frame index on the basis of the number of frames, the current playing time point and the frame playing time, and in combination with a frame index computation formula corresponding to the playing mode.
determining, by the playing sub-unit, the next effect video frame to be played from the video file according to the next video frame index, may include:
determining the next video frame playing position from the video file on the basis of the next video frame index;
extracting data information of all the image channels contained in the next video frame playing position; and
performing data mixing on the data information of all the image channels, and using an obtained texture image as the next effect video frame to be played in the video file.

On the basis of any optional technical solution in the embodiment of the present disclosure, optionally, the first displaying module 22 may further include an information determination unit; and

the information determination unit is configured to: during the process of playing the animation enhancement effect, according to the first pose information of the execution device, determine the effect display size of each effect video frame in the animation enhancement effect on the screen of the device.

The information determination unit may include:
a first determination sub-unit, configured to: according to the first pose information of the execution device, determine a space coordinate point of a camera in the augmented reality scenario;
an information acquisition sub-unit, configured to acquire initial plane information of a preset initial vertical plane in the augmented reality scenario; and
a second determination sub-unit, configured to: according to the space coordinate point and the initial plane information, and in combination with the set screen position, determine the effect display size of each effect video frame in the animation enhancement effect on the screen of the device.

The second determination sub-unit is configured to determine the effect display size of each effect video frame in the animation enhancement effect on the screen of the device in the following manner:
acquiring center point coordinates of the set screen position, and determining corresponding plane point coordinates of the center point coordinates on the initial vertical plane according to the space coordinate point and the initial plane information;
for each effect video frame in the animation enhancement effect, determining, on the initial vertical plane by using the plane point coordinates as the picture center point coordinates of the effect video frame, pixel point coordinates of pixel points in the effect video frame, which are presented on the initial vertical plane; and
on the basis of the pixel point coordinates, determining the corresponding effect display size of the effect video frame on the screen of the device.

On the basis of any optional technical solution in the embodiment of the present disclosure, optionally, the second displaying module 24 may include:
a state maintaining control unit, configured to continue to play the animation enhancement effect of the effect prop in the augmented reality scenario, and present the animation enhancement effect at the set screen position of the execution device in the effect display size.
the state maintaining control unit maintaining to present the effect display size at the set screen position of the execution device, may include:
constructing a target vertical plane in the augmented reality scenario according to the second pose information of the execution device; and
controlling the camera in the augmented reality scenario to capture the animation enhancement effect, and presenting the animation enhancement effect on the target vertical plane, so that the animation enhancement effect presented at the set screen position of the execution device maintains the effect display size.

On the basis of any optional technical solution in the embodiment of the present disclosure, optionally, the enhancement effect includes an auditory enhancement effect;
correspondingly, the first displaying module 22 is configured to play a sound enhancement effect of the effect prop in the augmented reality scenario in the following manner:
in the augmented reality scenario, playing the sound enhancement effect of the effect prop at a set sound effect playing rate, wherein the sound enhancement effect is synchronously played with the animation enhancement effect of the visual enhancement effect that is included in the enhancement effect.

On the basis of any optional technical solution in the embodiment of the present disclosure, optionally, the enhancement effect includes a tactile enhancement effect; and
correspondingly, the first displaying module 22 may include:
a vibration enhancement unit, configured to: in the augmented reality scenario, when a vibration enhancement condition of the effect prop is met, present a vibration enhancement effect by means of controlling a vibration apparatus on the execution device.
the vibration enhancement unit presenting the vibration enhancement effect by means of controlling the vibration apparatus on the execution device, may include:
acquiring vibration parameter information corresponding to the currently satisfied vibration enhancement condition; and
on the basis of the vibration parameter information, controlling the vibration apparatus to vibrate to present the vibration enhancement effect, wherein the vibration parameter information includes a vibration amplitude, a vibration frequency, and a vibration duration.

On the basis of any optional technical solution in the embodiment of the present disclosure, optionally, the effect prop is a firework prop; and

the enhancement effect corresponding to the firework prop includes: a firework blooming animation, firework explosion sound, firework explosion flash, and a firework explosion vibration sense.

The above apparatus may execute the method provided in any embodiment of the present disclosure, and has corresponding functional modules and beneficial effects for executing the method.

It is worth noting that, various units and modules included in the above apparatus are only divided according to functional logic, but is not limited to the above division, as long as corresponding functions may be implemented; and in addition, the names of various functional units are merely for ease of distinguishing each other.

### Embodiment 3

FIG. 3 is a schematic structural diagram of an electronic device provided in Embodiment 3 of the present disclosure. Referring to FIG. 3 below, it illustrates a schematic structural diagram of an electronic device (e.g., an electronic device or a server in FIG. 3) 30 suitable for implementing the embodiment of the present disclosure. The electronic device in the embodiment of the present disclosure may include mobile terminals such as mobile phones, notebook computers, digital broadcast receivers, personal digital assistants (PDAs), portable Android devices (PADs), portable media players (PMPs), vehicle-mounted terminals (e.g., vehicle-mounted navigation terminals), and the like, and fixed terminals such as digital television (i.e., digital TVs), desktop computers, and the like. The electronic device shown in FIG. 3 is merely an example.

As shown in FIG. 3, the electronic device 30 may include a processing apparatus (e.g., a central processing unit, a graphics processing unit, or the like) 31, and the processing apparatus may execute various suitable actions and processes in accordance with a program stored in a read only memory (ROM) 32 or a program loaded from a storage apparatus 38 into a random access memory (RAM) 33. In the RAM 33, various programs and data needed by the operations of the electronic device 30 are also stored. The processing apparatus 31, the ROM 32 and the RAM 33 are connected with each other via a bus 35. An input/output (I/O) interface 34 is also connected to the bus 35.

In general, the following apparatuses may be connected to the I/O interface 34: an editing apparatus 36, including, for example, a touch screen, a touch pad, a keyboard, a mouse, a camera, a microphone, an accelerometer, a gyroscope, and the like; an output apparatus 37, including, for example, a liquid crystal display (LCD), a speaker, a vibrator, and the like; a storage apparatus 38, including, for example, a magnetic tape, a hard disk, and the like; and a communication apparatus 39. The communication apparatus 39 may allow the electronic device 30 to communicate in a wireless or wired manner with other devices to exchange data. Although FIG. 3 illustrates the electronic device 30 having various apparatuses, it should be understood that not all illustrated apparatuses are required to be implemented or provided. More or fewer apparatuses may alternatively be implemented or provided.

In one embodiment, according to the embodiment of the present disclosure, the processes described above with reference to the flowcharts may be implemented as computer software programs. For example, the embodiment of the present disclosure includes a computer program product, which includes a computer program carried on a non-transient computer-readable medium, and the computer program contains program codes for executing the method illustrated in the flowcharts. In such an embodiment, the computer program may be downloaded and installed from a network via the communication apparatus 39, or installed from the storage apparatus 38, or installed from the ROM 32. When the computer program is executed by the processing apparatus 31, the above functions defined in the method of the embodiments of the present disclosure are executed.

The names of messages or information interacted between a plurality of apparatuses in the embodiments of the present disclosure are for illustrative purposes only and are not intended to limit the scope of these messages or information.

The electronic device provided in the embodiment of the present disclosure belongs to the same inventive concept as the effect prop display method provided in the above embodiments, for technical details that are not described in detail in the present embodiment, reference may be made to the above embodiments, and the present embodiment has the same beneficial effects as the above embodiments.

### Embodiment 4

The embodiment of the present disclosure provides a computer storage medium, on which a computer program is stored, wherein the program implements, when being executed by a processor, the effect prop display method provided in the above embodiments.

It should be noted that, the computer-readable medium described above in the present disclosure may be either a computer-readable signal medium or a computer-readable storage medium, or any combination of the two. The computer-readable storage medium may be, for example, an electrical, magnetic, optical, electromagnetic, infrared, or semiconductor system, apparatus or device, or a combination of any of the above. Examples of the computer-readable storage medium may include an electrical connection having one or more wires, a portable computer magnetic disk, a hard disk, a random access memory, a read only memory, an erasable programmable read-only memory (e.g., an electronic programmable read only memory (EPROM) or a flash memory), an optical fiber, a compact disc-read only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including: an electrical wire, an optical cable, radio frequency (RF), and the like, or any suitable combination thereof.

In some embodiments, a client and a server may perform communication by using any currently known or future-developed network protocol, such as a hypertext transfer protocol (HTTP), and may be interconnected with any form or medium of digital data communication (e.g., a communication network). Examples of the communication network include a local area network (LAN), a wide area network (WAN), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries at least one program that, when being executed by the electronic device, causes the electronic device to perform the following operations:

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer by means of any type of network, including a local area network (LAN) or a wire area network (WAN), or it may be connected to an external computer (e.g., by means of the Internet using an Internet service provider).

The flowcharts and block diagrams in the drawings illustrate the system architectures, functions and operations of possible implementations of systems, methods and computer program products according to various embodiments of the present disclosure. In this regard, each block in the flowcharts or block diagrams may represent a part of a module, a program segment, or a code, which contains at least one executable instruction for implementing specified logical functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that, each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case, for example, a first acquisition unit may also be described as “a unit for acquiring at least two Internet Protocol addresses”.

The functions described herein above may be executed, at least in part, by at least one hardware logic component. For example, example types of the hardware logic component that may be used include: a field programmable gate array (FPGA), an application specific integrated circuit (ASIC), application specific standard parts (ASSPs), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include an electronic, magnetic, optical, electromagnetic, infrared, or semiconductor system, apparatus or device, or any suitable combination thereof. Examples of the machine-readable storage medium may include an electrical connection based on at least one wire, a portable computer disk, a hard disk, a random access memory (RAM), a read only memory (ROM), an erasable programmable read-only memory (an EPROM or a flash memory), an optical fiber, a portable compact disc-read only memory (CD-ROM), an optical storage device, a magnetic storage device, or any suitable combination thereof.

According to one or more embodiments of the present disclosure, Example 1 provides a effect prop display method, including:
receiving a trigger operation of a effect prop in an execution device, wherein the execution device currently has first pose information;
displaying an enhancement effect of the effect prop in a set display state;
receiving a pose adjustment operation on the execution device, wherein the first pose information of the execution device is changed into second pose information; and
keeping displaying the enhancement effect of the effect prop while maintaining the set display state.

According to one or more embodiments of the present disclosure, Example 2 provides a effect prop display method, wherein the enhancement effect in the method includes a visual enhancement effect; and correspondingly, displaying the enhancement effect of the effect prop in the set display state includes:

playing an animation enhancement effect of the effect prop in an augmented reality scenario, and presenting the animation enhancement effect at a set screen position of the execution device in a predetermined effect display size.

According to one or more embodiments of the present disclosure, Example 3 provides a effect prop display method, wherein the method further includes:

during the process of playing the animation enhancement effect, when the animation enhancement effect is played to a preset time point, superimposing a light enhancement effect and presenting the same.

According to one or more embodiments of the present disclosure, Example 4 provides a effect prop display method, wherein playing the animation enhancement effect of the effect prop in the augmented reality scenario includes:

acquiring a video file corresponding to the effect prop, wherein the video file is stored in a set video format; and decoding the video file, and playing decoded effect video frames in the augmented reality scenario.

According to one or more embodiments of the present disclosure, Example 5 provides a effect prop display method, wherein decoding the video file, and playing the decoded effect video frames in the augmented reality scenario includes:
acquiring playing parameters and the current playing information of the video file;
decoding the next effect video frame to be played according to the playing parameters and the current playing information, and playing the next effect video frame to be played in the augmented reality scenario.

According to one or more embodiments of the present disclosure, Example 6 provides a effect prop display method, wherein determining the next video frame index according to the playing parameters and the current playing information of the video file, and in combination with the set playing mode, includes:
extracting, from the playing parameter information, a playing duration of the video file, a playing rate of the video file and the number of effect video frames, and acquiring the current playing time point from the current playing information;
determining a frame playing time of the video file according to the playing duration and the playing rate; and
determining the next video frame index on the basis of the number of frames, the current playing time point and the frame playing time, and in combination with a frame index computation formula corresponding to the playing mode.

According to one or more embodiments of the present disclosure, Example 7 provides a effect prop display method, wherein determining the next effect video frame to be played from the video file according to the next video frame index includes:
determining the next video frame playing position from the video file on the basis of the next video frame index;
extracting data information of all the image channels contained in the next video frame playing position; and
performing data mixing on the data information of all the image channels, and using an obtained texture image as the next effect video frame to be played in the video file.

According to one or more embodiments of the present disclosure, Example 8 provides a effect prop display method, wherein the method further includes:

during the process of playing the animation enhancement effect, according to the first pose information of the execution device, determining the effect display size of each effect video frame in the animation enhancement effect on the screen of the device.

According to one or more embodiments of the present disclosure, Example 9 provides a effect prop display method, wherein according to the first pose information of the execution device, determining the effect display size of each effect video frame in the animation enhancement effect on the screen of the device, includes:
according to the first pose information of the execution device, determining a space coordinate point of a camera in the augmented reality scenario;
acquiring initial plane information of a preset initial vertical plane in the augmented reality scenario; and
according to the space coordinate point and the initial plane information, and in combination with the set screen position, determining the effect display size of each effect video frame in the animation enhancement effect on the screen of the device.

According to one or more embodiments of the present disclosure, Example 10 provides a effect prop display method, wherein according to the space coordinate point and the initial plane information, and in combination with the set screen position, determining the effect display size of each effect video frame in the animation enhancement effect on the screen of the device, includes:
acquiring center point coordinates of the set screen position, and determining corresponding plane point coordinates of the center point coordinates on the initial vertical plane according to the space coordinate point and the initial plane information;
for each effect video frame in the animation enhancement effect, determining, on the initial vertical plane by using the plane point coordinates as the picture center point coordinates of the effect video frame, pixel point coordinates of pixel points in the effect video frame, which are presented on the initial vertical plane; and
on the basis of the pixel point coordinates, determining the corresponding effect display size of the effect video frame on the screen of the device.

According to one or more embodiments of the present disclosure, Example 11 provides a effect prop display method, wherein keeping displaying the enhancement effect of the effect prop while maintaining the set display state, includes:
continuing to play the animation enhancement effect of the effect prop in the augmented reality scenario, and presenting the animation enhancement effect at the set screen position of the execution device in the effect display size.

According to one or more embodiments of the present disclosure, Example 12 provides a effect prop display method, wherein presenting the animation enhancement effect at the set screen position of the execution device in the effect display size includes:
constructing a target vertical plane in the augmented reality scenario according to the second pose information of the execution device; and
controlling the camera in the augmented reality scenario to capture the animation enhancement effect, and presenting the animation enhancement effect on the target vertical plane, so that the animation enhancement effect presented at the set screen position of the execution device maintains the effect display size.

According to one or more embodiments of the present disclosure, Example 13 provides a effect prop display method, wherein the method further includes:

According to one or more embodiments of the present disclosure, Example 14 provides a effect prop display method, wherein the enhancement effect includes an auditory enhancement effect; and
correspondingly, displaying the enhancement effect of the effect prop in the set display state includes:
in the augmented reality scenario, playing a sound enhancement effect of the effect prop at a set sound effect playing rate,
wherein the sound enhancement effect is synchronously played with the animation enhancement effect of the visual enhancement effect that is included in the enhancement effect.

According to one or more embodiments of the present disclosure, Example 15 provides a effect prop display method, wherein the enhancement effect includes a tactile enhancement effect; and
correspondingly, displaying the enhancement effect of the effect prop in the set display state includes:
in the augmented reality scenario, when a vibration enhancement condition of the effect prop is met, presenting a vibration enhancement effect by means of controlling a vibration apparatus on the execution device.

According to one or more embodiments of the present disclosure, Example 16 provides a effect prop display method, wherein presenting the vibration enhancement effect by means of controlling the vibration apparatus on the execution device includes:
acquiring vibration parameter information corresponding to the currently satisfied vibration enhancement condition; and
on the basis of the vibration parameter information, controlling the vibration apparatus to vibrate to present the vibration enhancement effect,
wherein the vibration parameter information includes a vibration amplitude, a vibration frequency, and a vibration duration.

According to one or more embodiments of the present disclosure, Example 17 provides a effect prop display method, wherein the effect prop is a firework prop; and

the enhancement effect corresponding to the firework prop includes: a firework blooming animation, firework explosion sound, firework explosion flash, and a firework explosion vibration sense.

According to one or more embodiments of the present disclosure, Example 18 provides a effect prop interaction apparatus, including:
a first receiving module, configured to receive a trigger operation of a effect prop in an execution device, wherein the execution device currently has first pose information;
a first displaying module, configured to display an enhancement effect of the effect prop in a set display state;
a second receiving module, configured to receive a pose adjustment operation on the execution device, wherein the first pose information of the execution device is changed into second pose information; and
a second displaying module, configured to maintain the set display state, and continue to display the enhancement effect of the effect prop.

What is claimed is:

1. A effect prop display method, comprising:
receiving a trigger operation of a effect prop in an execution device, wherein the execution device currently has first pose information;
displaying an enhancement effect of the effect prop in a set display state;
receiving a pose adjustment operation on the execution device, wherein the first pose information of the execution device is changed into second pose information; and
keeping displaying the enhancement effect of the effect prop based on maintaining the set display state.

2. The method according to claim 1, wherein the enhancement effect comprises a visual enhancement effect; and
displaying the enhancement effect of the effect prop in the set display state comprises:
playing an animation enhancement effect of the effect prop in an augmented reality scenario, and presenting the animation enhancement effect at a set screen position of the execution device in a predetermined effect display size.

3. The method according to claim 2, wherein the method further comprises:
during the process of playing the animation enhancement effect, in a case that the animation enhancement effect is played to a preset time point, superimposing a light enhancement effect and presenting the same.

4. The method according to claim 2, wherein playing the animation enhancement effect of the effect prop in the augmented reality scenario comprises:
acquiring a video file corresponding to the effect prop, wherein the video file is stored in a set video format; and
decoding the video file, and playing decoded effect video frames in the augmented reality scenario.

5. The method according to claim 4, wherein decoding the video file, and playing the decoded effect video frames in the augmented reality scenario comprises:
acquiring playing parameters and the current playing information of the video file;
decoding the next effect video frame to be played according to the playing parameters and the current playing information, and playing the next effect video frame to be played in the augmented reality scenario.

6. The method according to claim 5, wherein decoding the next effect video frame to be played according to the playing parameters and the current playing information comprises:
determining the next video frame index according to the playing parameters and the current playing information of the video file, and in combination with a set playing mode; and
determining the next effect video frame to be played from the video file according to the next video frame index.

7. The method according to claim 6, wherein determining the next video frame index according to the playing parameters and the current playing information of the video file, and in combination with the set playing mode, comprises:
extracting, from the playing parameter information, a playing duration of the video file, a playing rate of the video file and the number of effect video frames, and acquiring the current playing time point from the current playing information;
determining a frame playing time of the video file according to the playing duration and the playing rate; and
determining the next video frame index on the basis of the number of frames, the current playing time point and the frame playing time, and in combination with a frame index computation formula corresponding to the playing mode.

8. The method according to claim 6, wherein determining the next effect video frame to be played from the video file according to the next video frame index comprises:
determining the next video frame playing position from the video file on the basis of the next video frame index;
extracting data information of all the image channels contained in the next video frame playing position; and
performing data mixing on the data information of all the image channels, and using an obtained texture image as the next effect video frame to be played in the video file.

9. The method according to claim 2, wherein during the process of playing the animation enhancement effect, the method further comprises:
according to the first pose information of the execution device, determining the effect display size of each effect video frame in the animation enhancement effect on the screen of the device.

10. The method according to claim 9, wherein according to the first pose information of the execution device, determining the effect display size of each effect video frame in the animation enhancement effect on the screen of the device, comprises:
according to the first pose information of the execution device, determining a space coordinate point of a camera in the augmented reality scenario;
acquiring initial plane information of a preset initial vertical plane in the augmented reality scenario; and
according to the space coordinate point and the initial plane information, and in combination with the set screen position, determining the effect display size of each effect video frame in the animation enhancement effect on the screen of the device.

11. The method according to claim 10, wherein according to the space coordinate point and the initial plane information, and in combination with the set screen position, determining the effect display size of each effect video frame in the animation enhancement effect on the screen of the device, comprises:
acquiring center point coordinates of the set screen position, and determining corresponding plane point coordinates of the center point coordinates on the initial vertical plane according to the space coordinate point and the initial plane information;
for each effect video frame in the animation enhancement effect, determining, on the initial vertical plane by using the plane point coordinates as the picture center point coordinates of the effect video frame, pixel point coordinates of pixel points in the effect video frame, which are presented on the initial vertical plane; and
on the basis of the pixel point coordinates, determining the corresponding effect display size of the effect video frame on the screen of the device.

12. The method according to claim 2, wherein keeping displaying the enhancement effect of the effect prop based on maintaining the set display state, comprises:
continuing to play the animation enhancement effect of the effect prop in the augmented reality scenario, and presenting the animation enhancement effect at the set screen position of the execution device in the effect display size.

13. The method according to claim 12, wherein presenting the animation enhancement effect at the set screen position of the execution device in the effect display size comprises:
constructing a target vertical plane in the augmented reality scenario according to the second pose information of the execution device; and
controlling the camera in the augmented reality scenario to capture the animation enhancement effect, and presenting the animation enhancement effect on the target vertical plane, so that the animation enhancement effect presented at the set screen position of the execution device maintains the effect display size.

14. The method according to claim 1, wherein enhancement effect comprises an auditory enhancement effect; and
displaying the enhancement effect of the effect prop in the set display state comprises:
in the augmented reality scenario, playing a sound enhancement effect of the effect prop at a set sound effect playing rate,
wherein the sound enhancement effect is synchronously played with the animation enhancement effect of the visual enhancement effect that is comprised in the enhancement effect.

15. The method according to claim 1, wherein the enhancement effect comprises a tactile enhancement effect; and
displaying the enhancement effect of the effect prop in the set display state comprises:
in the augmented reality scenario, in a case that a vibration enhancement condition of the effect prop is met, presenting a vibration enhancement effect by means of controlling a vibration apparatus on the execution device.

16. The method according to claim 15, wherein presenting the vibration enhancement effect by means of controlling the vibration apparatus on the execution device comprises:
acquiring vibration parameter information corresponding to the currently satisfied vibration enhancement condition; and
on the basis of the vibration parameter information, controlling the vibration apparatus to vibrate to present the vibration enhancement effect,
wherein the vibration parameter information comprises a vibration amplitude, a vibration frequency, and a vibration duration.

17. The method according to claim 1, wherein the effect prop is a firework prop; and
the enhancement effect corresponding to the firework prop comprises: a firework blooming animation, firework explosion sound, firework explosion flash, and a firework explosion vibration sense.

18. (canceled)

19. An electronic device, comprising:
a processor; and
a storage apparatus, configured to store a program, wherein, when the program is executed by the processor, the processor implements the acts comprising:
receiving a trigger operation of a effect prop in an execution device, wherein the execution device currently has first pose information;
displaying an enhancement effect of the effect prop in a set display state;
receiving a pose adjustment operation on the execution device, wherein the first pose information of the execution device is changed into second pose information; and
keeping displaying the enhancement effect of the effect prop based on maintaining the set display state.

20. A non-transitory computer-readable storage medium, on which a computer program is stored, wherein the computer program implements, when being executed by a processor, the acts comprising:
receiving a trigger operation of a effect prop in an execution device, wherein the execution device currently has first pose information;
displaying an enhancement effect of the effect prop in a set display state;
receiving a pose adjustment operation on the execution device, wherein the first pose information of the execution device is changed into second pose information; and
keeping displaying the enhancement effect of the effect prop based on maintaining the set display state.

21. The non-transitory computer-readable storage medium according to claim 20, wherein the enhancement effect comprises a visual enhancement effect; and
displaying the enhancement effect of the effect prop in the set display state comprises:
playing an animation enhancement effect of the effect prop in an augmented reality scenario, and presenting the animation enhancement effect at a set screen position of the execution device in a predetermined effect display size.
